(19) United States
(12) Patent Application Publication
(10) Pub. No.: US 2019/0136414 A1
(43) Pub. Date: May 9, 2019

(54) METHOD FOR REGENERATING REINFORCING FIBERS

(71) Applicant: MITSUBISHI HEAVY INDUSTRIES, LTD., Tokyo (JP)

(72) Inventors: Wataru NISHIMURA, Tokyo (JP); Masayuki KANEMASU, Tokyo (JP); Kodai SHIMONO, Tokyo (JP)

(21) Appl. No.: 16/183,942

(22) Filed: Nov. 8, 2018

(30) Foreign Application Priority Data
Nov. 9, 2017 (JP) 2017-216287

(51) Int. Cl. D01D 10/00; C01B 32/05

(52) U.S. Cl. CPC D01D 10/00; D10B 2101/12; C01B 32/05

(57) ABSTRACT

A method for regenerating reinforced fiber includes binding a part of a composite member containing reinforcing fibers and resins oriented in directions different from each other along a direction intersecting a longitudinal direction of the composite member; removing the resins from the composite member; and separating unbound reinforced fibers from bound reinforced fibers among the reinforced fibers.

### BACKGROUND OF THE INVENTION

### Field of the Invention

The present invention relates to a method for regenerating reinforcing fibers.

Priority is claimed on Japanese Patent Application No. 2017-216287, filed Nov. 9, 2017, the content of which is incorporated herein by reference.

### Description of Related Art

Some composite members contain fibers and resin oriented in directions different from each other.

For example, Patent Document 1 discloses, as a composite member, a carbon fiber reinforced plastic member in which a UD material with carbon fibers oriented in one direction and a cross member with carbon fibers oriented in a grid pattern are combined and laminated.

### PATENT DOCUMENTS

[Patent Document 1] Japanese Unexamined Patent Application, First Publication No. 2015-98282

### SUMMARY OF THE INVENTION

In order to recycle the carbon fibers contained in the composite member disclosed in Patent Document 1, it is necessary to remove the resin and extract the carbon fibers.

However, depending on the form of the composite member, carbon fibers having different lengths which are mixed together may be extracted. For this reason, the lengths of the carbon fibers which are recovered may be uneven.

An object of the present invention is to provide a method for regenerating reinforced fibers in which reinforcing fibers having a uniform length are able to be regenerated.

The method for regenerating reinforced fibers of a first aspect includes a process of binding some of a composite member containing reinforced fibers and resin oriented in directions different from each other in a direction intersecting a longitudinal direction of the composite member; a process of removing the resin from the composite member; and a process of separating unbound reinforcing fibers from bound reinforcing fibers among the reinforcing fibers.

In this aspect, a part of a composite member containing reinforcing fibers and resin oriented in directions different from each other is bound in a direction intersecting the longitudinal direction of the composite member, the resin is removed, and unbound reinforcing fibers are separated from bound reinforcing fibers. The bound reinforcing fibers contain a large amount of reinforcing fibers oriented in the longitudinal direction of the composite member. Therefore, the reinforcing fiber bundles which are recovered have a uniform length in respective reinforcing fibers and can be regenerated as high-quality reinforcing fibers.

The method for regenerating reinforced fibers of a second aspect is the method for regenerating reinforced fibers of the first aspect, wherein the part is a part of one end side of the composite member.

The method for regenerating reinforced fibers according to a third aspect is the method for regenerating reinforced fibers of the first or second aspect, wherein the removing process removes unbound reinforcing fibers, using air blowing, combing, or flowing of water.

The method for regenerating reinforced fibers of a fourth aspect is the method for regenerating reinforced fibers of any one of the first to third aspects, further including: a process of cutting the bound reinforcing fibers after the removing process.

The method for regenerating reinforced fibers of a fifth aspect is the method for regenerating reinforced fibers of any one of the first to fourth aspects, wherein the reinforcing fibers are carbon fibers.

According to one aspect of the present invention, reinforcing fibers of uniform length can be regenerated.

### BRIEF DESCRIPTION OF THE DRAWINGS

FIG. 1 is a flowchart of a method for regenerating reinforced fibers according to an embodiment of the present invention.

FIG. 2 is a diagram showing a binding process in the embodiment according to the present invention.

FIG. 3 is a diagram showing a process of removing a resin in the embodiment according to the present invention.

FIG. 4 is a diagram showing a process of separating the reinforcing fibers in the embodiment according to the present invention.

FIG. 5 is a diagram showing a process of cutting the reinforcing fibers according to the embodiment of the present invention.

FIG. 6 is a diagram showing a comparison of lengths of reinforcing fibers.

### DETAILED DESCRIPTION OF THE INVENTION

Hereinafter, a method for regenerating reinforced fibers according to an embodiment of the present invention will be described with reference to the drawings.

### Embodiment

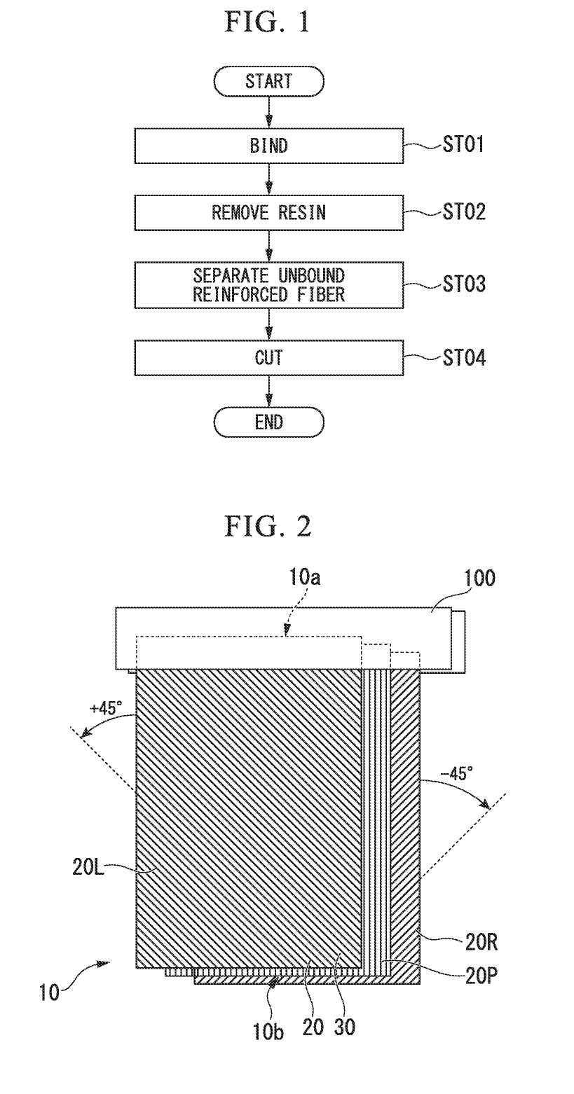

Hereinafter, a method for regenerating fiber will be described with reference to FIGS. 1 to 6.

The method for regenerating reinforced fibers of the present embodiment is applied to a composite member 10 containing reinforcing fibers 20 and resin 30 oriented in directions different from each other.

In the present embodiment, carbon fibers are used as the reinforcing fibers 20.

As shown in FIG. 1, the method for regenerating reinforced fibers includes a binding process (ST01), a process of removing resin (ST02), a process of separating reinforcing fibers (ST03), and a process of cutting reinforcing fibers (ST04).

In the present embodiment, the composite member 10 is a rectangular plate member. The composite member 10 has a first end 10a and a second end 10b at respective longitudinal ends of a rectangle.

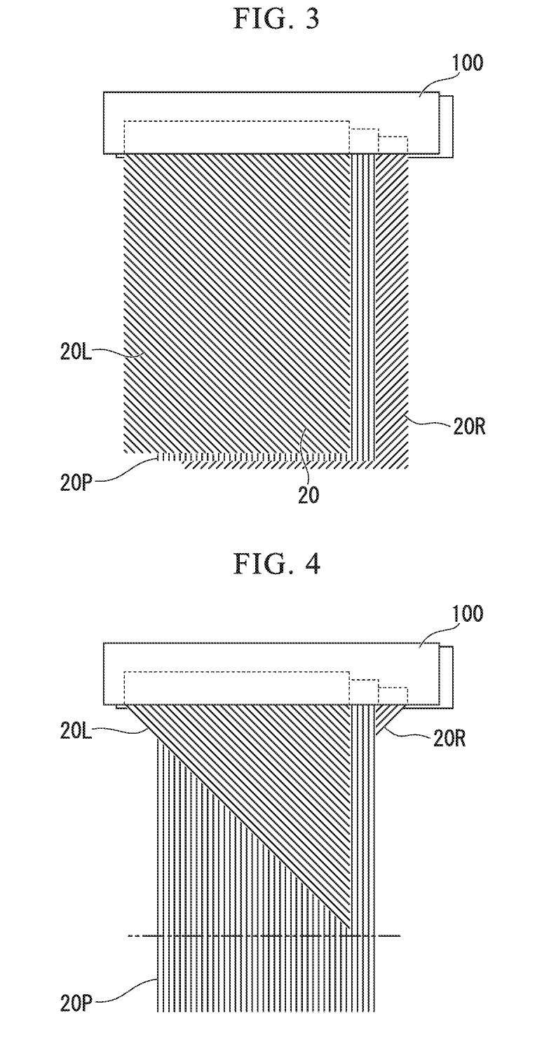

As shown in FIG. 2, the composite member 10 has three kinds of reinforced fibers 20 oriented in directions different from each other.

Among the three kinds of reinforced fibers 20, first reinforced fibers 20P are oriented in the longitudinal direction of the composite member 10.

Among the three kinds of reinforced fibers 20, second reinforced fibers 20L are oriented at +45° with respect to the longitudinal direction of the composite member 10.

Among the three kinds of reinforced fibers 20, third reinforced fibers 20R are oriented at −45° with respect to the longitudinal direction of the composite member 10.

In the present embodiment, the composite member 10 is a cured carbon fiber reinforced plastic (CFRP). In fact, three types of reinforcing fibers 20 are cured together in a single CFRP board, although three types are schematically made apparent in FIG. 2.

### (Binding Process)

First, ST01 is executed. In ST01, an operator binds a part of the composite member 10 containing the reinforced fibers and resin oriented in directions different from each other with the binding member 100, along a direction intersecting the longitudinal direction of the composite member.

The binding member 100 is, for example, a double clip. The binding member 100 binds the composite member 10 by applying pressure to both plate surfaces of the composite member 10. The binding member 100 extends in the direction intersecting the longitudinal direction of the composite member, and can bind objects sandwiched together in the extending direction.

In ST01, the operator binds a part of the composite member 10 with the binding member 100, along a direction intersecting the longitudinal direction of the composite member, that is, a direction intersecting the orientation direction of the first reinforced fiber 20P. In the present embodiment, the composite member 10 is bound by the binding member 100 along the direction orthogonal to the longitudinal direction of the composite member 10.

Specifically, the binding member 100 binds the composite member 10 in the direction in which the binding member 100 extends along the direction orthogonal to the longitudinal direction of the composite member 10.

As shown in FIG. 2, in the present embodiment, the binding member 100 binds a part of the plate surface of the composite member 10 on the side of the first end 10a in the longitudinal direction across both sides in a lateral direction. At this time, a plate surface on the second end 10b side in the longitudinal direction is not bound.

### (Process of Removing Resin)

ST02 is executed subsequent to ST01. In ST02, the operator removes the resin 30 from the bound composite member 10, while binding the composite member 10. In order to remove the resin 30 from the composite member 10, for example, a firing method, a dissolution method, a subcritical fluid method, or the like is used. The resin is not required to be completely removed, but may be at least removed to such an extent that the reinforced fiber 20 is stretched.

In ST02, since the binding member 100 applies pressure from both sides of the composite member 10 to bind the composite member 10, even if the resin 30 is removed from the composite member 10, the reinforced fiber 20 remaining after removal of the resin 30 is bound by the binding member 100.

In a case where the binding member 100 is a clamping mechanism such as a double clip that applies a pressure to a clamping portion with a spring, the binding member 100 sandwiching the two surfaces of the composite member 10 has a mechanism for clamping the two surfaces of the composite member 10 while a pressure is applied. Therefore, as the resin 30 is removed, the binding member 100 can continue to tighten the remaining reinforced fibers 20. As a result, the binding member 100 can bind the reinforced fibers 20 remaining after removal of the resin 30.

In this embodiment, when the resin 30 is removed, as shown in FIG. 3, all the first reinforced fiber 20P, a part of the second reinforced fiber 20L, and a part of the third reinforced fibers 20R are bound with the binding member 100.

### (Process of Separating Reinforced Fiber)

ST03 is executed subsequent to ST02. In ST03, the operator separates the unbound reinforced fiber 20 from the bound reinforced fiber 20 among the reinforced fibers 20.

In ST03, by applying a force in a direction along the orientation of the first reinforced fiber 20P to the reinforced fiber 20 remaining after removal of the resin 30 by air blowing, comb or water flow, some of the reinforced fibers 20 are separated from the reinforced fibers 20. Here, some of the reinforced fibers to be separated are the reinforced fibers 20 which are not bound by the binding member 100. As shown in HG 4, in this embodiment, among the second reinforced fiber 20L and the third reinforced fiber 20R, the second reinforced fiber 20L and the third reinforced fiber 20R which are not bound by the binding member 100 are removed from the reinforced fiber 20 bound by the binding member 100. On the other hand, all the first reinforced fiber 20P, a part of the second reinforced fiber 20L, and a part of the third reinforced fiber 20R bound by the binding member 100 remain.

### (Cutting Process)

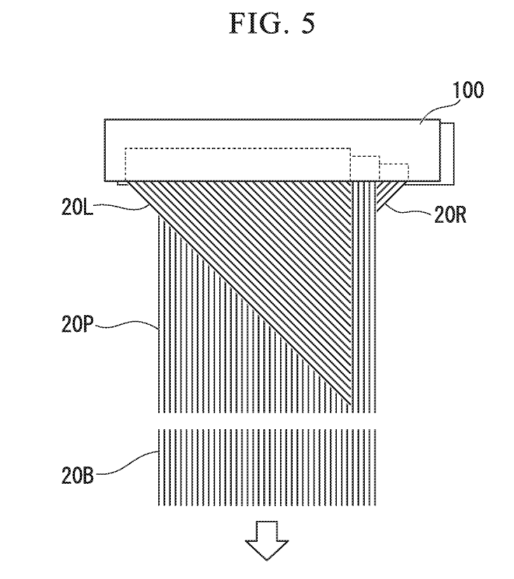

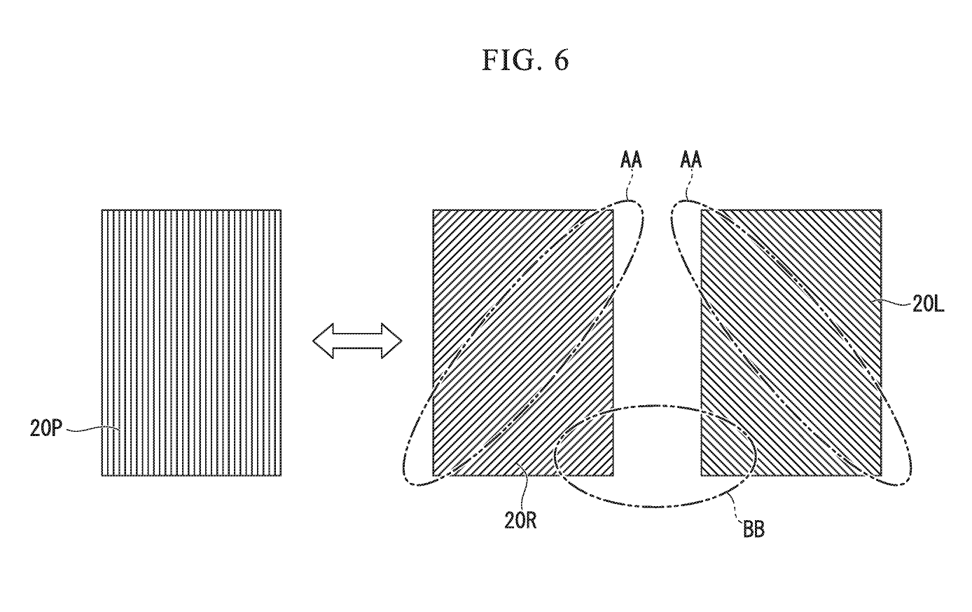

ST04 is executed subsequent to ST03. In ST04, the operator cuts the first reinforced fiber 20P among all the bound first reinforced fibers 20P, a part of the second reinforced fibers 20L and a part of the third reinforced fibers 20R. At this time, the first reinforced fiber 20P is cut at a double dotted-dashed line portion shown in FIG. 4. When cut at the two-dot chain line portion, as shown in FIG. 5, it is possible to recover a reinforced fiber bundle 20B in which hardly any of the second reinforced fibers 20L and the third reinforced fibers 20R are contained and a larger amount of first reinforced fibers 20P is contained.

Here, the two-dot chain line portion shown in FIG. 4 is a line extending in a direction intersecting the first reinforced fiber 20P, and is a line drawn at a position which does not intersect a part of the second reinforced fiber 20L and a part of the third reinforced fiber 20R bound together. In the present embodiment, the two-dot chain line portion extends orthogonally to the orientation direction of the first reinforced fiber 20P.

### (Actions and Effects)

The method for regenerating fiber of the present embodiment binds a part of a composite member containing reinforced fibers and resins oriented in directions different from each other along a direction intersecting the longitudinal direction of the composite member, and separates the bound reinforced fibers and unbound reinforced fibers. The bound reinforced fibers contain a large amount of reinforced fibers oriented in the longitudinal direction of the composite member. Therefore, the reinforced fiber bundles to be recovered have the uniform length of each reinforced fiber and are regenerated as high-quality reinforced fiber.

In particular, in the method for regenerating fiber of the present embodiment, the composite member 10 is bound along the direction orthogonal to the longitudinal direction of the composite member 10. Therefore, it is possible to recover the reinforced fiber bundle 20B containing a larger amount of the first reinforced fibers 20P. Therefore, the recovered reinforced fiber bundle 20B has the same length of each reinforced fiber and is regenerated as a high-quality reinforced fiber.

As shown in FIG. 6, the lengths of the second reinforced fiber 20L and the third reinforced fiber 20R are not uniform as compared with that of the first reinforced fiber 20P contained in the composite member 10.

Each reinforced fiber in a portion of AA shown in FIG. 6 is longer than each reinforced fiber shown in a portion of BB. Therefore, since at least a part of the second reinforced fibers 20L and at least a part of the third reinforced fibers 20R having non-uniform lengths are separated from the first reinforced fiber 20P, it is possible to recover the reinforced fibers having the uniform lengths.

In the present embodiment, the material of the binding member 100 may be any material as long as it is possible to withstand the process of removing the resin.

In the case of the firing method, the material of the binding member 100 needs to have heat resistance, and it is preferable that the binding member 100 withstand a high temperature of 600° C. or higher. For example, iron or light metals (aluminum, magnesium, etc.) are desirable.

According to the melting method or the subcritical fluid method, the material of the binding member 100 is preferably one having chemical resistance. For example, stainless steel or chemical resistant resins (PEEK, PEKK, PPS, etc.) are desirable.

If a material that can withstand the process of removing the resin is used for the binding member 100, it is possible to maintain a continuous pressure when binding in the process of removing the resin.

### Modified Examples

In the present embodiment, the carbon fibers are regenerated as the reinforced fibers 20, but other fibers may be regenerated. As a modified example, glass fibers may be regenerated as the reinforced fibers 20.

In the present embodiment, a part of the plate surface of the composite member 10 on the first end 10a side in the longitudinal direction is bound. However, if a part of the composite member is bound along the direction intersecting the longitudinal direction of the composite member, any part can be bound.

As a modified example, a part of the plate surface at a center portion of the composite member 10 in the longitudinal direction may be bound across both sides in the lateral direction.

In the present embodiment, one binding member binds one composite member.

As a modified example, one binding member may bind a plurality of composite members together. For example, in a case in which the composite members are plate members, a plurality of composite members may be disposed such that their plate surfaces are arranged side by side, and the plurality of composite members may be bound by one bind member over a plurality of plate surfaces arranged side by side.

In this embodiment, a process ST04 of cutting the reinforced fiber with respect to all the first reinforced fiber 20P, a part of the second reinforced fiber 20L, and a part of the third reinforced fiber 20R remaining unseparated is executed. However, according to the following modified example, the process ST04 of cutting the reinforced fiber is not necessarily performed.

As a modified example, the binding member is switched to another binding member, and among all the first reinforced fiber 20P, a part of the second reinforced fiber 20L and a part of the third reinforced fiber 20R remaining unseparated, a part of the second reinforced fiber 20L and a part of the third reinforced fiber 20R may be further separated from the first reinforced fiber 20P. Specifically, after ST03, the operator binds the reinforced fiber on the second end 10b side with the other binding member 100, removes the binding member 100 on the first end 10a side, and again executes ST03. Therefore, the operator can remove a part of the second reinforced fiber 20L and a part of the third reinforced fiber 20R from the first reinforced fiber 20P, among all the first reinforced fiber 20P, a part of the second reinforced fiber 20L and a part of the third reinforced fiber 20R remaining unseparated.

As another modified example, when the operator binds the reinforced fiber in the direction along the second reinforced fiber with respect to the composite member having the first reinforced fiber and the second reinforced fiber orthogonal to each other, and executes ST02 and ST03, it is possible to separate the second reinforced fiber from the first reinforced fiber.

In the process ST04 of cutting the reinforced fiber, the first reinforced fiber 20P is cut at the two-dot chain line portion shown in FIG. 4.

As a modified example, the first reinforced fiber 20P may be cut on the side of the first end 10a with respect to the two-dot chain line portion shown in FIG. 4. Although the second reinforced fiber 20L and the third reinforced fiber 20R are somewhat included, it is possible to recover the reinforced fiber bundle 20B containing a large amount of the first reinforced fibers 20P.

As another modified example, the first reinforced fiber 20P may be cut at the side closer to the second end 10b than the two-dot chain line portion shown in FIG. 4.

Since the remaining reinforced fibers contain a large number of reinforced fibers uniform in one direction, the operator can easily cut and length with arbitrary lengths.

In this embodiment, the operator executes each process, but at least one process from respective processes may be executed by the device. For example, a process of operating the binding member by a robot to perform binding through the robot may be executed. Likewise, a process of removing the resin with the robot by moving the composite member into and out of a furnace or a container through the robot may be executed. Further, for example, a cutting machine may execute the cutting process, and the process of separating the reinforced fibers may be executed by a device such as a robot or an air blowing device.

While several embodiments of the invention have been described, these embodiments are presented by way of example and are not intended to limit the scope of the invention. These embodiments can be implemented in various other forms, and various omissions, substitutions, and changes can be made within the scope that does not depart from the gist of the invention. These embodiments or modified examples thereof are included in the invention described in the claims and the equivalent scope thereof as well as being included in the scope and gist of the invention.

### INDUSTRIAL APPLICABILITY

According to one aspect of the present invention, reinforced fibers of uniform length can be regenerated.

### EXPLANATION OF REFERENCES

10 Composite member
10a First end
10b Second end
20 Reinforced fiber
20B Reinforced fiber bundle
20P First reinforced fiber
20L Second reinforced fiber
20R Third reinforced fiber
30 Resin
100 Binding member
ST01 Binding process
ST02 Process of removing resin
ST03 Process of separating reinforced fiber
ST04 Cutting process

What is claimed is:

1. A method for regenerating reinforced fiber, the method comprising:
binding a part of a composite member containing reinforced fibers and resins oriented in directions different from each other along a direction intersecting a longitudinal direction of the composite member;
removing the resins from the composite member; and
separating unbound reinforced fibers from bound reinforced fibers among the reinforced fibers.

2. The method for regenerating reinforced fiber according to claim 1, wherein the part is a part of one end side of the composite member.

3. The method for regenerating reinforced fiber according to claim 1, wherein the removing process removes unbound reinforced fibers, by an air blow, a comb or a water flow.

4. The method for regenerating reinforced fiber according to claim 1, further comprising:
the cutting of the bound reinforced fibers after the removing process.

5. The method for regenerating reinforced fiber according to claim 1, wherein the reinforced fibers are carbon fibers.
